(19) United States
(12) Patent Application Publication
(10) Pub. No.: US 2002/0197021 A1
(43) Pub. Date: Dec. 26, 2002

(54) Semiconductor laser module

(75) Inventor: Yoshihisa Kusunoki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/162,381

(22) Filed: Jun. 5, 2002

(30) Foreign Application Priority Data
Jun. 22, 2001 (JP) 2001-189908

(51) Int. Cl. G02B 6/42

(52) U.S. Cl. 385/88; 385/92

(57) ABSTRACT

In a ferrule, the face of a clamping fixing portion nipped and fixed by fixing portions is formed on the face of a shape along a face (clamping fixing face) of the fixing portion for clamping and fixing the ferrule. The ferrule is fixed to the fixing portions by welding on this face. The clearance between the ferrule and the fixing portion is easily managed by forming the clamping fixing portion of the ferrule on the face of the shape along the clamping fixing face of the fixing portion. Thus, fixing strength of the welding between the ferrule and the fixing portion can be stabilized.

### FIELD OF THE INVENTION

The present invention relates to a semiconductor laser module in which a semiconductor laser element is arranged in an optical coupling state to an optical fiber.

### BACKGROUND OF THE INVENTION

The semiconductor laser module has a construction in which a semiconductor laser element is stored into e.g., a package in a state optically coupled to an optical fiber.

There is a lensed fiber as one kind of the optical fiber. A lens is formed in a tip portion of this lensed fiber, and the lensed fiber can be optically coupled to the semiconductor laser element without using any separate independent lens.

### SUMMARY OF THE INVENTION

The present invention in one aspect provides the following semiconductor laser module. Namely, the semiconductor laser module comprises:

a semiconductor laser element; and

an optical fiber;

wherein the optical fiber is inserted and fixed to a ferrule,

a pair of fixing portions is arranged in a mode in which a side face of the ferrule is nipped from both sides by the fixing portions,

the face of a ferrule portion nipped by the fixing portions is formed on the face of a shape along a clamping fixing face of each of the fixing portions, and

the ferrule is fixed to the fixing portions by welding on this face.

### BRIEF DESCRIPTION OF THE DRAWINGS

Exemplary embodiments of the invention will now be described in conjunction with drawings in which:

FIG. 1 is a perspective view typically showing a main constructional portion of a semiconductor laser module of one embodiment in this invention.

FIG. 2A is a perspective view for explaining a ferrule of the semiconductor laser module of FIG. 1, and FIG. 2B is a plan view of the ferrule of FIG. 2A seen from a forward side.

FIG. 3A is a side view showing one mode example of a lens formed in a tip portion of a lensed fiber, and FIG. 3B is a plan view of a lens forming portion of the lensed fiber shown in FIG. 3A seen from an upper side.

Each of FIGS. 4A and 4B is a model diagram showing a mode example of a part for fixation having a fixing portion.

FIG. 5 is a model diagram showing one mode example of a base constituting the semiconductor laser module of FIG. 1.

FIGS. 6A, 6B, 6C, 6D, 6E, 6F, 6G and 6H are respectively views for explaining other embodiments.

FIG. 7 is a model diagram showing one example of the semiconductor laser module in section.

FIG. 8 is a plan view of a main constructional portion of the semiconductor laser module shown in FIG. 7 and seen from an upper side.

FIG. 9 is a model diagram showing one example of the ferrule.

FIG. 10 is a model diagram showing one example of the fixing portion.

FIG. 11 is a view for explaining an aligning work of an optical fiber.

FIG. 12A is a view for explaining one example of a process for welding and fixing the ferrule to the fixing portion, and FIG. 12B is a view for explaining one example of a welding fixing process subsequently to FIG. 12A.

### DETAILED DESCRIPTION

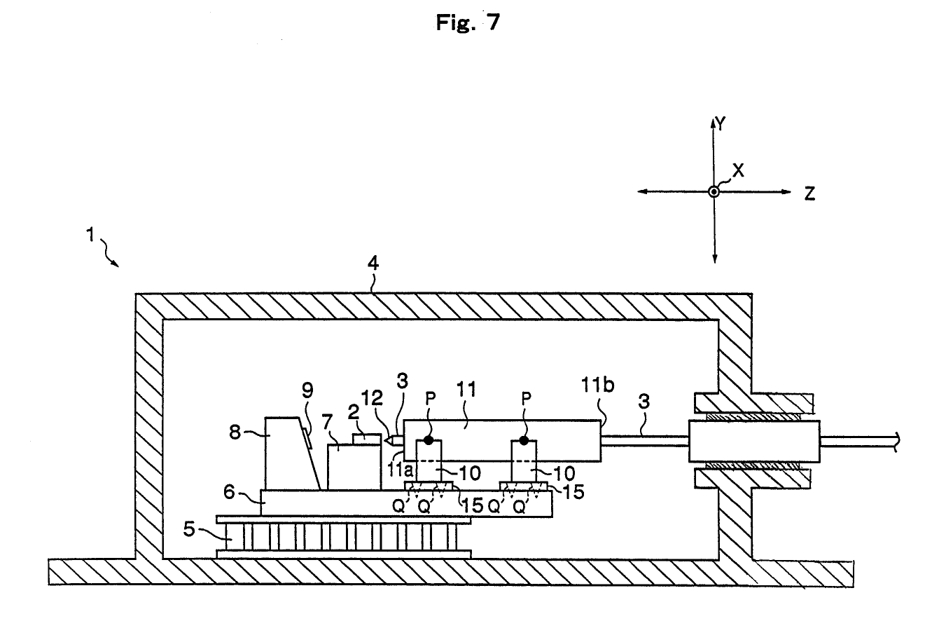

In FIG. 7, one structural example of a semiconductor laser module is shown by a typical sectional view. This semiconductor laser module 1 is constructed by storing and arranging a semiconductor laser element 2 within a package 4 in an optical coupling state to an optical fiber 3.

In this semiconductor laser module 1, a thermo module 5 is fixed to the interior of the package 4, and a metallic base 6 is fixed to an upper portion of this thermo module 5. The semiconductor laser element 2 is fixed to an upper face of the base 6 through a chip carrier 7. A photodiode 9 is fixed to this upper face of the base 6 through a support base 8, and an unillustrated thermistor is arranged in the vicinity of the semiconductor laser element 2.

The photodiode 9 monitors a light emitting state of the semiconductor laser element 2. The thermo module 5 controls temperature of the semiconductor laser element 2. An operation of this thermo module 5 is generally controlled on the basis of the detecting temperature of a thermistor so as to set the temperature of the semiconductor laser element 2 to a predetermined desirable temperature. Changes in intensity and wavelength of a laser beam of the semiconductor laser element 2 caused by a change in the temperature of the semiconductor laser element 2 are restrained by the temperature control of the thermo module 5. Thus, the intensity and the wavelength of the laser beam of the semiconductor laser element 2 are approximately constantly maintained.

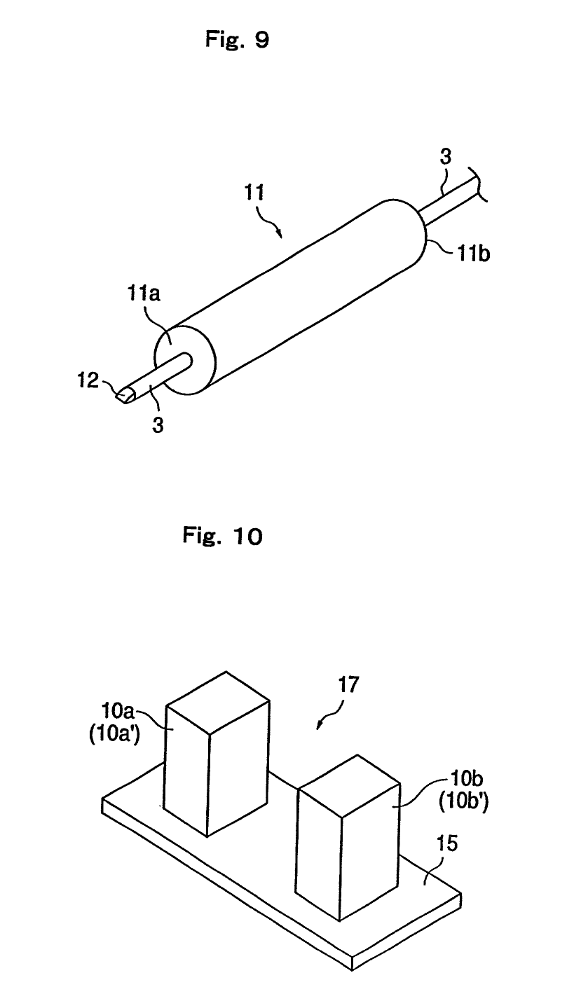

Further, a ferrule 11 is fixed to the base 6 through a fixing portion 10. The ferrule 11 is constructed by a metal, and is formed in a columnar shape as shown in FIG. 9. For example, an Fe—Ni—Co alloy (e.g., KOVAR (trademark)) can be used as one example of the metal constituting this ferrule 11.

An unillustrated through hole is formed within the ferrule 11 such that this through hole extends from a front end face 11a to a rear end face 11b. An optical fiber 3 is inserted into this through hole, and is fixed by e.g., solder.

A tip portion of the optical fiber 3 is projected forward from the front end portion 11a of the ferrule 11, and is spaced from a light emitting portion of the semiconductor laser element 2. This tip portion of the optical fiber 3 receives the laser beam emitted from the semiconductor laser element 2. In this example, a lens 12 is formed in the tip portion of the optical fiber 3 so that the optical fiber 3 is formed as a lensed fiber.

The optical fiber 3 pulled out of the rear end face 11b of the ferrule 11 is guided to the exterior of the package 4. The laser beam incident to the tip portion of the optical fiber 3 from the semiconductor laser element 2 is propagated in the optical fiber 3 and is guided to a predetermined desirable supply place.

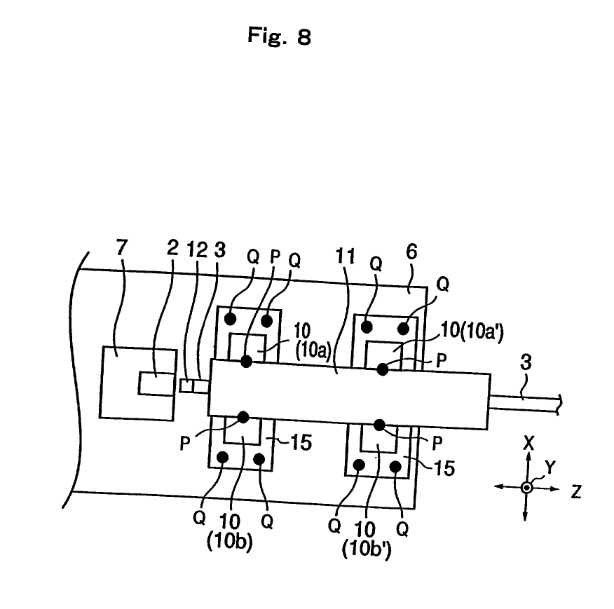

FIG. 8 shows a plan view in which a portion fixing the ferrule 11 thereto is extracted and seen from an upper side. In FIG. 10, one example of the fixing portion 10 is shown by a perspective view. A side face of the ferrule 11 is nipped by a pair of fixing portions 10 (10a, 10b, 10a′, 10b′) from both sides on tip and rear end sides of the ferrule 11. The ferrule 11 is fixed to the fixing portions 10 (10a, 10b, 10a′, 10b′) by laser welding (e.g., YAG laser welding). In FIGS. 7 and 8, a welding portion of the ferrule 11 is shown by a black circle P.

As shown in FIG. 10, fixing portions 10a, 10b (10a′, 10b′) as a pair are formed on a common substrate 15 and constitute a part 17 for fixation. For example, this part 17 for fixation is fixed to the base 6 by laser welding in a position Q shown in FIG. 8.

In a process for fixing the ferrule 11 to the fixing portion 10, an aligning work of the semiconductor laser element 2 and the optical fiber 3 is made. One example of this aligning work will next be shown. For example, the semiconductor laser element 2 is fixed to the base 6 through a chip carrier 7. Further, the part 17 for fixation for fixing a tip side of the ferrule 11 is arranged in a movable state in a position presumed as a fixing position on the base 6. In this state, the tip side of the ferrule 11 is arranged between the fixing portions 10a and 10b of the part 17 for fixation, and is welded and fixed. In this case, the ferrule 11 is welded and fixed to the fixing portion 10 so as to approximately conform the height position of an optical axis of the semiconductor laser element 2 with respect to the base 6 and the height position of an optical axis of the optical fiber 3 (i.e., align the position of the optical axis of the semiconductor laser element 2 and the position of the optical axis of the optical fiber 3 in a Y-axis direction).

Thereafter, the part 17 for fixation fixed to the tip side of the ferrule 11 is moved in an X-axis direction and a Z-axis direction such that the optical axis of the optical fiber 3 is conformed to the optical axis of the semiconductor laser element 2. Thus, the optical axes of the semiconductor laser element 2 and the optical fiber 3 are aligned with each other in the X-axis direction and the Z-axis direction. Thereafter, while this state is held, the substrate 15 of the part 17 for fixation is fixed to the base 6 by the welding.

The fixing portion 10 (substrate 15) may be fixed to the base 6 in advance and the ferrule 11 may be then welded and fixed to this fixing portion 10 such that the optical axis of the optical fiber 3 is conformed to the optical axis of the semiconductor laser element 2 when the ferrule 11 is fixed to the fixing portion 10.

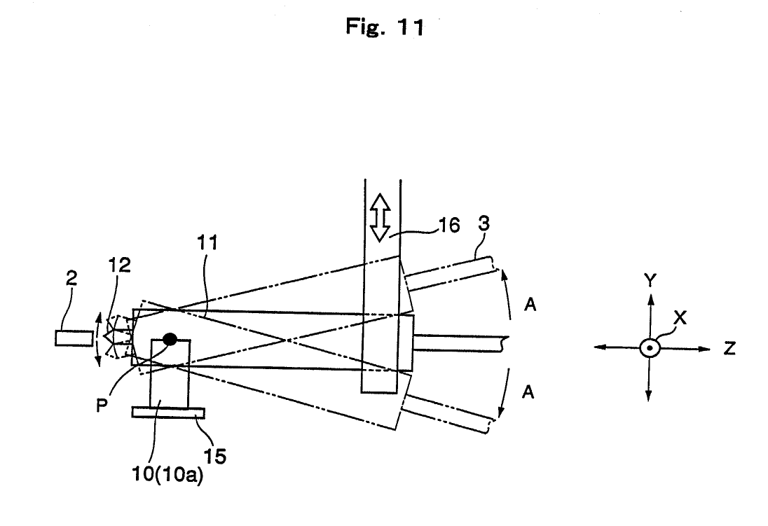

Thereafter, as shown in FIG. 11, a rear end side of the ferrule 11 is tilted by using an aligning tool 16 as shown by an arrow A with a welding fixing portion P on a tip side as a fulcrum. Thus, a tip portion of the optical fiber 3 is slightly moved in the Y-axis direction, and the optical axis of the optical fiber 3 is slightly adjusted such that the optical axis of the optical fiber 3 is more precisely conformed to the optical axis of the semiconductor laser element 2 in the Y-axis direction. Thereafter, while this state after the fine adjustment is maintained, the rear end side of the ferrule 11 is welded and fixed to the fixing portions 10a′, 10b′. Thus, the ferrule 11 is fixed to the base 6 by the fixing portions 10a′, 10b′ and the substrate 15. Here, the ferrule 11 may be also fixed to the base 6 after the substrate 15 is fixed to the base 6.

Since the ferrule 11 is fixed to the base 6 through the fixing portion 10 by making such an aligning work, the semiconductor laser element 2 and the tip portion of the optical fiber 3 are stored and arranged within the package 4 in a state in which the optical axis of the semiconductor laser element 2 and the optical axis of the optical fiber 3 are precisely aligned with each other.

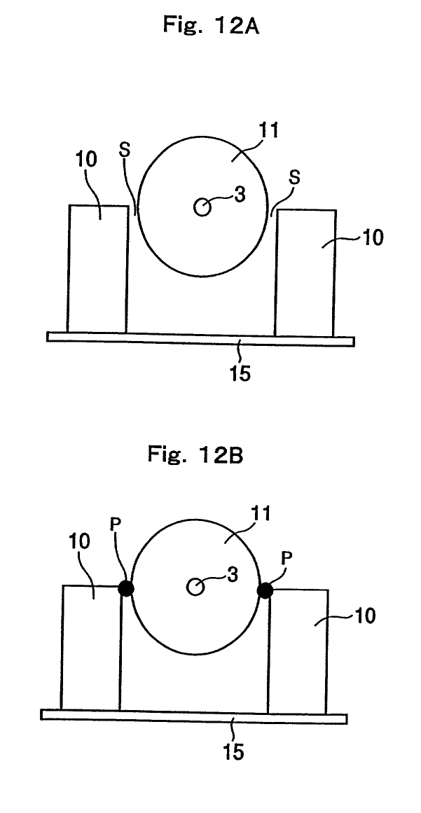

When the ferrule 11 is welded and fixed to the fixing portion 10, the ferrule 11 is first arranged between the pair of fixing portions 10 through small clearances S with respect to these fixing portions 10 as shown in FIG. 12A. In this state, as shown in FIG. 12B, the ferrule 11 is welded and fixed to each fixing portion 10. It is preferable that the clearance S between the fixing portion 10 and the ferrule 11 is not dispersed but is constant for every product to prevent the fixing strength by the welding between the fixing portion 10 and the ferrule 11 from being dispersed depending upon the product.

However, since the ferrule 11 is formed in a columnar shape, the clearance S between the ferrule 11 and the fixing portion 10 is changed by only slightly vertically displacing the ferrule 11 so as to conform the optical axis of the optical fiber 3 to the optical axis of the semiconductor laser element 2. Therefore, a problem exists in that it is difficult to set the clearance S between the ferrule 11 and the fixing portion 10 to a set size.

In the ferrule 11, a metallic film is formed by performing plating processing. For example, an Au film can be used as one of this metallic film.

Corrosion of the ferrule 11 can be prevented by this plating film. Further, when the ferrule 11 and the optical fiber 3 are fixed to each other by solder, wettability of the solder can improved. However, it is difficult to precisely form the metallic film by the plating such that the metallic film has a set thickness. Therefore, every ferrule 11 is dispersed in diameter 11. Such dispersion of the diameter of the ferrule 11 is also one of causes of the difficulty of management of the clearance S between the ferrule 11 and the fixing portion 10.

It is necessary to prepare plural kinds of parts 17 for fixation at different distances between the pair of fixing portions 10 to relax such a problem.

Otherwise, the following solving technique is considered. For example, a state capable of changing the distance between the fixing portions 10 is set by setting at least one side of the pair of fixing portions 10 to be movable. The height position of the ferrule 11 is adjusted such that the height position of the optical axis of the optical fiber 3 becomes the height position of the optical axis of the semiconductor laser element 2. Thereafter, the distance between the pair of fixing portions 10 is fixed such that the clearance S between the ferrule 11 and the fixing portion 10 becomes a set size. The ferrule 11 and the fixing portion 10 are then welded and fixed. However, in this case, the problem of making the fixing work of the ferrule 11 and the fixing portion 10 very difficult is caused.

The present invention in one aspect provides a semiconductor laser module which can enable to easily manage the clearance between the ferrule and the fixing portion and simplify the fixing work of the ferrule and the fixing portion.

Embodiments in this invention will next be explained on the basis of the drawings.

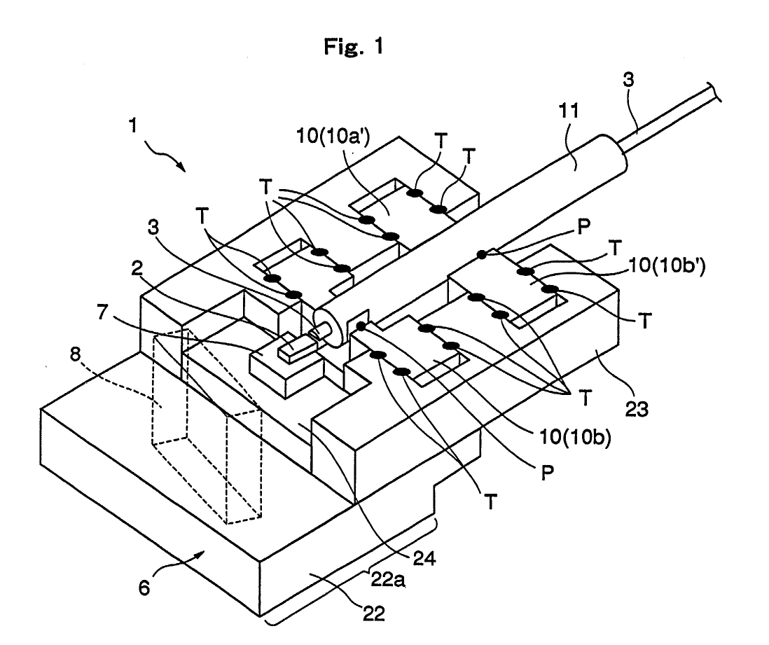

A main constructional portion of a semiconductor laser module of one embodiment in the present invention is extracted and typically shown in FIG. 1. In the explanation of this embodiment, the same constructional portions as the semiconductor laser module shown in FIG. 7 are designated by the same reference numerals, and overlapping explanations of these common portions are omitted.

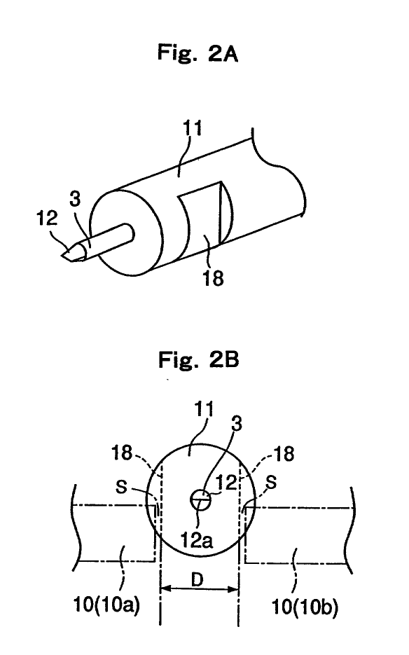

FIG. 2A shows a perspective view of a tip portion of a ferrule 11 constituting the semiconductor laser module of this embodiment. FIG. 2B shows a view of this ferrule 11 seen from its tip side. In this embodiment, a face (clamping fixing face) for clamping and fixing the ferrule 11 to each of fixing portions 10a, 10b is formed in a planar shape perpendicular to the face of a base 6.

Further, in this embodiment, a portion (clamping fixing portion) 18 nipped and fixed by each of the fixing portions 10a, 10b is formed in a perpendicular planar shape on a tip side of the ferrule 11. In this clamping fixing portion 18 of the planar shape, the ferrule 11 is plated and is then cut in a planar shape by a machine work. Namely, a plating film is removed from this clamping fixing portion 18. Thus, the distance D between planar portions of the clamping fixing portions 18 opposed to each other can be precisely set to a set size by forming the clamping fixing portion 18 of the planar shape by the machine work. Further, in this embodiment, the clamping fixing portions 18 opposed to each other are formed approximately in parallel with each other. The clamping fixing portion 18 of the ferrule 11 may be also processed in the planar shape after the ferrule 11 is plated and the optical fiber 3 is inserted and fixed. Further, the optical fiber 3 may be also inserted and fixed to the ferrule 11 after the ferrule 11 is plated and the clamping fixing portion 18 of this ferrule 11 is formed in the planar shape.

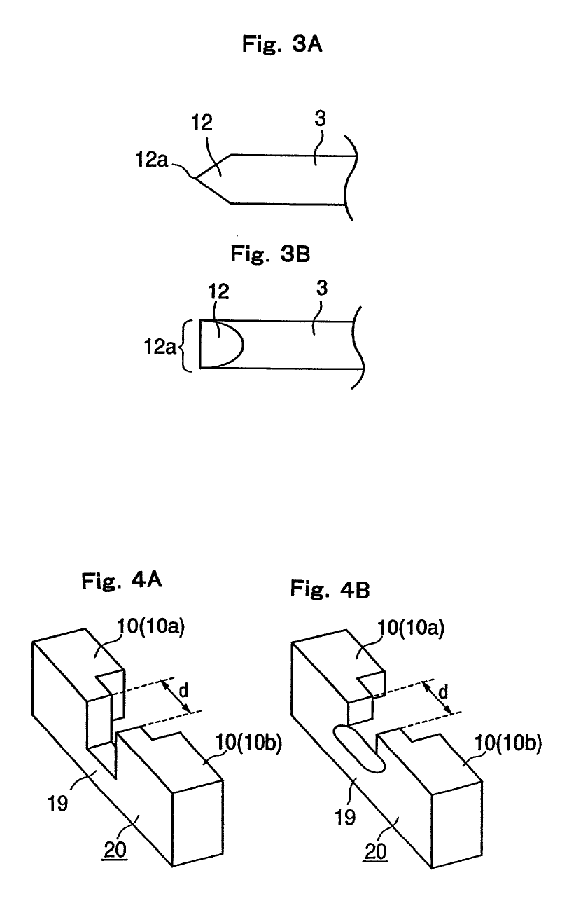

In this embodiment, the optical fiber 3 is formed as a lensed fiber. As shown in the side view of FIG. 3A and the plan view of FIG. 3B, a lens 12 in a tip portion of the optical fiber 3 is formed as an anamorphic (rotating asymmetrical) lens of a wedge type. The height position of the optical fiber 3 is adjusted such that this lens 12 optically couples the laser beam of a semiconductor laser element 2 and the optical fiber.

A planar face of the clamping fixing portion 18 of the ferrule 11 is formed approximately perpendicularly to a ridge line 12a of a tip portion of the lens 12. In this embodiment, the ferrule 11 is arranged in a posture in which the planar face of the clamping fixing portion 18 and a planar face of the fixing portion 10 opposed to this planar face of the clamping fixing portion 18 are approximately parallel to each other.

The optical fiber 3 can be arranged in a correct direction in which the lens 12 of the optical fiber 3 optically couples the laser beam of the semiconductor laser element 2 and the optical fiber by the arrangement relation of the planar face of the clamping fixing portion 18 of the ferrule 11, the ridge line 12a of the tip portion of the lens 12, and a side face of the fixing portion 10.

Further, in this embodiment, as shown in FIGS. 4A and 4B, a part 20 for fixation is constructed by connecting and integrating the pair of fixing portions 10a, 10b for clamping and fixing the tip side of the ferrule 11 through a connecting portion 19. Such a part 20 for fixation is manufactured by the machine work, and the distance d between the pair of fixing portions 10a and 10b is approximately set to a designed size.

Thus, the distance d between the pair of fixing portions 10a and 10b is set to the designed size, and the width D of the clamping fixing portion 18 of the ferrule 11 nipped by these fixing portions 10a, 10b can be also set to a designed size. Thus, the ferrule 11 and the fixing portion 10 can be arranged precisely in size such that the clearance S between the clamping fixing portion 18 of the ferrule 11 and the fixing portion 10 is set to a set size.

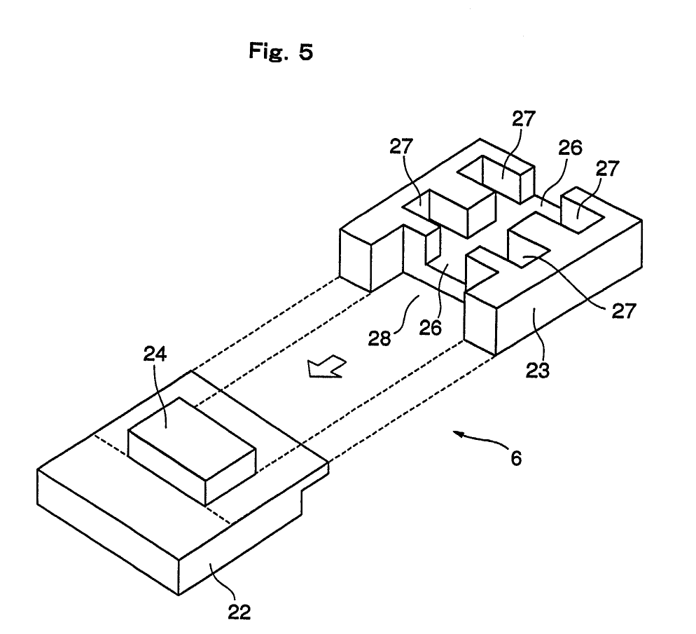

In this embodiment, the base 6 is constructed by combining plural members as shown in FIG. 5. Namely, the base 6 is constructed by arranging a member 22 for mounting the semiconductor laser element and a member 23 for mounting a fixing means. An semicondactor laser element bonding portion 24 is integrally formed in the member 22 for mounting the semiconductor laser element. The semiconductor laser element 2 is mounted to an upper portion of this semicondactor laser element bonding portion 24 through a chip carrier 7. Further, a photodiode 9 is mounted to the member 22 for mounting the semiconductor laser element through a support base 8.

A ferrule arranging portion 26 and a fixing portion arranging portion 27 are bored and formed in the member 23 for mounting the fixing means. A fitting portion 28 for fitting the semicondactor laser element bonding portion 24 of the member 22 for mounting the semiconductor laser element thereinto is formed in the member 23 for mounting the fixing means.

The fixing portion 10 is fitted into the fixing portion arranging portion 27, and this fixing portion 10 and the member 23 for mounting the fixing means are welded and fixed in e.g., a position T of FIG. 1. The ferrule 11 is stored and arranged in the ferrule arranging portion 26 in a state in which the fixing portion 10 is stored and fixed to the fixing portion arranging portion 27. While an aligning work of the ferrule 11 is made, the ferrule 11 is fixed to the fixing portion 10 within the fixing portion arranging portion 27 by welding (e.g., YAG laser welding) in e.g., a position P. As mentioned above, the fixing portions 10a, 10b for fixing the tip side of the ferrule 11 is formed in the shape of the part 20 for fixation integrated as shown by e.g., FIGS. 4A and 4B. Fixing portions 10a′, 10b′ for fixing a rear end side of the ferrule 11 are respectively formed in separate independent rectangular shapes.

The member 23 for mounting the fixing means is fixed and arranged in the member 22 for mounting the semiconductor laser element in a state in which the fitting portion 28 and the semicondactor laser element bonding portion 24 of the member 22 for mounting the semiconductor laser element are fitted to each other.

The above base 6 is fixed to the upper face of a thermo module 5 with a bottom face 22a of the member 22 for mounting the semiconductor laser element as a fixing face.

In accordance with this embodiment, since the clamping fixing portion 18 on the tip side of the ferrule 11 is formed in the planar shape, it is easy to manage the clearances between the clamping fixing portions 18 on both sides of this ferrule 11 and the fixing portions 10a, 10b. In particular, in this embodiment, after the ferrule 11 is plated, the clamping fixing portion 18 is cut and is processed and formed in the planar shape. Therefore, the distance D between the planar portions of the clamping fixing portions 18 opposed to each other can be set to a designed size without being badly influenced by dispersion in the thickness of the plating film. As a result, the clearance between the clamping fixing portion 18 on the tip side of the ferrule 11 and each of the fixing portions 10a, 10b can be approximately set to a set size. Accordingly, it is possible to prevent the dispersion of fixing strength due to the welding between the ferrule 11 and the fixing portion 10 for every product.

Further, since the distance D between the planar portions of the clamping fixing portions 18 opposed to each other can be precisely set to the designed size, it is not necessary to prepare plural kinds of parts for fixation at different distances d between the pair of fixing portions 10a and 10b. Further, it is possible to omit a complicated operation in which the distance d between the pair of fixing portions 10a and 10b is in a variable state and is adjusted in accordance with the distance between the clamping fixing portions on both sides of the ferrule 11 and is then fixed. Accordingly, the fixing work of the fixing portion 10 and the ferrule 11 can be simplified.

Further, in this embodiment, the following effects can be obtained since the clearances between the clamping fixing portions 18 on both the sides of the ferrule 11 and the fixing portions 10a, 10b are easily managed.

It has been found that the ferrule 11 is slightly sunk on a lower side after the ferrule 11 is welded and fixed to the fixing portion 10. In consideration of this matter, the ferrule 11 is arranged on an upper side by an amount sunk after the welding in comparison with a set fixing position of the ferrule 11 when the ferrule 11 is welded and fixed to the fixing portion 10 (this amount is called an offset amount). There is a case in which the ferrule 11 is welded and fixed to the fixing portion 10 in this state. This is because the ferrule 11 is arranged in a set height position by the sinking of the ferrule 11 after the welding.

However, when the clearance between the ferrule 11 and the fixing portion 10 is dispersed, fixing strength of the welding between the ferrule 11 and the fixing portion 10 is dispersed by this dispersion of the clearance. The sinking amount of the ferrule 11 after the welding is also dispersed by this dispersion of the fixing strength. Therefore, it was difficult to set the offset amount.

In contrast to this, in this embodiment, since the clearance between the ferrule 11 and the fixing portion 10 can be approximately set to a set size, the fixing strength of the welding between the ferrule 11 and the fixing portion 10 can become approximately constant. Thus, the sinking amount of the ferrule 11 after the welding is stabilized so that the offset amount is easily set and the ferrule 11 can be approximately arranged in a set height position.

The fixing strength in the welding of the tip side of the ferrule 11 and the fixing portion 10 is important when an aligning work for aligning the optical axis of the optical fiber 3 with the optical axis of the semiconductor laser element 2 in position is made by tilting the ferrule 11 with a welding portion P on the tip side of the ferrule 11 as a fulcrum. It is particularly important to manage the clearance between the tip side of the ferrule 11 and the fixing portion 10 concerned in this fixing strength. Accordingly, the construction of this embodiment for facilitating this clearance management is very effective.

Further, in this embodiment, a plating film is removed from the clamping fixing portion 18. When a plating component is mixed into a welding portion, a reduction in melting point in the welding portion and a welding crack due to the deposition of an intermetallic compound are caused. For example, when KOVARs (melting point 1450° C.) are mutually welded and a substance (e.g., gold (melting point 1064° C.)) having a low melting point is mixed into these KOVARs, this portion of the low melting point substance is not easily solidified. Therefore, a welding crack is caused with this portion as a starting point. It is possible to prevent a problem caused by such mixture of the plating component by removing the plating film of a welding portion of the ferrule 11. Thus, reliability of the semiconductor laser module 1 can be raised.

Further, since a removing area of this plating film is the very limited portion of the clamping fixing portion 18, the above problem of the welding crack, etc. can be prevented while the problem of corrosion of the ferrule 11 is avoided.

Further, in this embodiment, since the ferrule 11 is fixed to the fixing portion 10 by the welding, the ferrule 11 can be approximately fixed in an object height position in comparison with a case in which the ferrule 11 is fixed by another means. Therefore, it is possible to prevent a problem in that the semiconductor laser module 1 becomes defective since the fixing height of the ferrule 11 is unsuitable. Further, yield can be improved.

This invention is not limited to this embodiment mode, but various embodiment modes can be adopted. For example, in this embodiment, the clamping fixing portion 18 on the tip side among the clamping fixing portions 18 on the tip side and the rear end side of the ferrule 11 is formed in the planar shape, but both the clamping fixing portions 18 on the tip side and the rear end side of the ferrule 11 may be also formed in the planar shape.

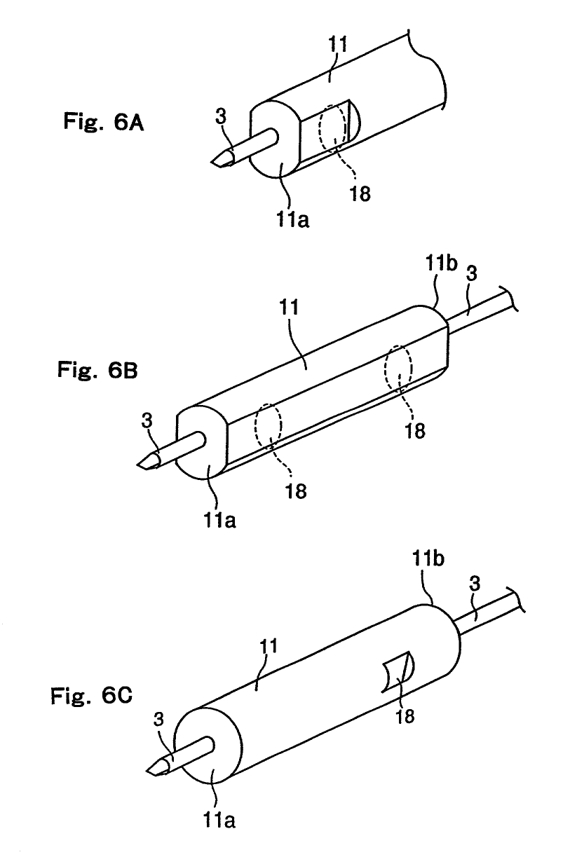

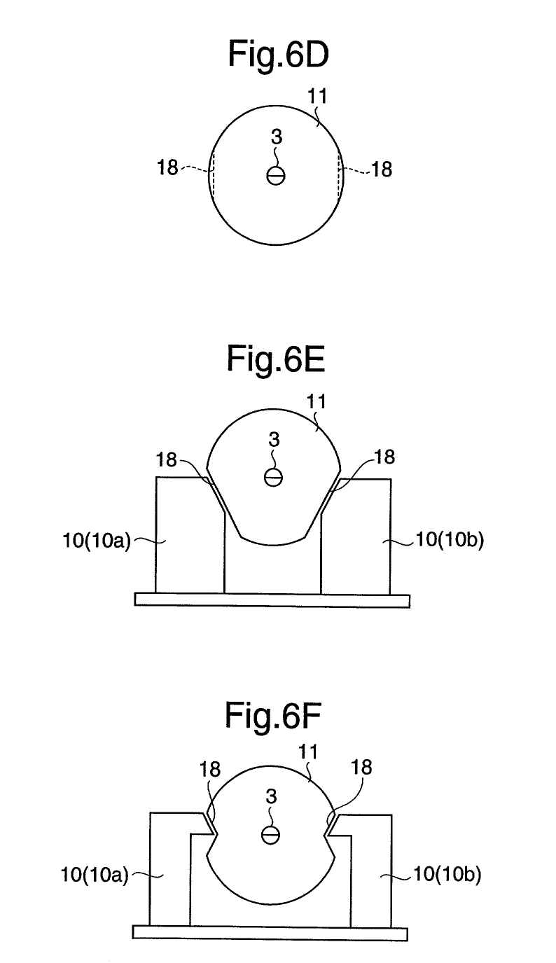

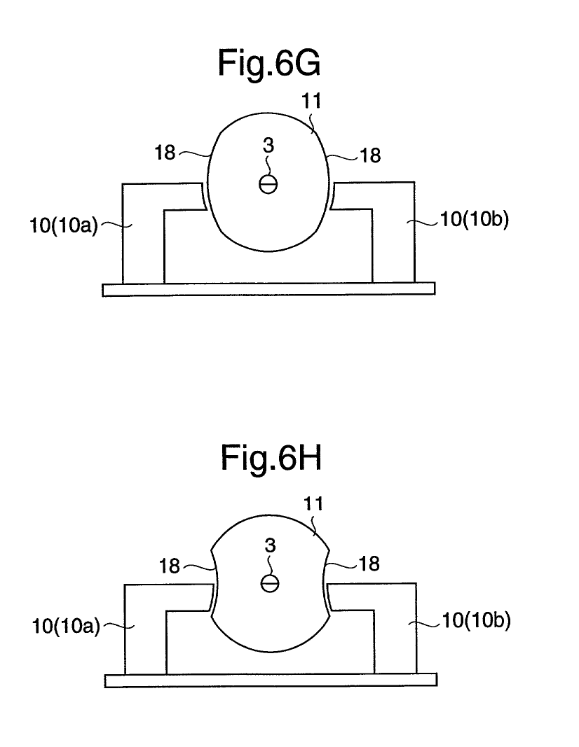

Further, as shown in FIG. 6C, only the clamping fixing portion 18 on the rear end side of the ferrule 11 may be also formed in the planar shape. For example, it is assumed that the ferrule 11 is slightly shifted from the set height position due to the above sinking of the ferrule 11 after the tip side of the ferrule 11 is welded to the fixing portion 10. In this case, when the rear end side of the ferrule 11 is welded and fixed to the fixing portion 10, the position of the welding fixation of the rear end side of this ferrule 11 and the fixing portion 10 is adjusted so that the sinking of the tip side of the ferrule 11 can be corrected. Thus, although the position shift of the tip side of the ferrule 11 is caused, the semiconductor laser element 2 and the optical fiber 3 can be optically coupled to each other.

However, when the rear end side of the ferrule 11 is shifted from the set position due to the dispersion of the sinking amount after the welding, a work for correcting the welding fixation on the rear end side of the ferrule 11 must be made. There is also a case in which no correction can be made so that the semiconductor laser module becomes defective.

In contrast to this, in this embodiment, similar to the above case, the clearance between the rear end side of the ferrule 11 and the fixing portion 10 is easily managed by forming the clamping fixing portion 18 on the rear end side of the ferrule 11 in a perpendicular planar shape. Accordingly, the dispersion of the sinking amount of the ferrule 11 after the welding can be restrained. Thus, the rear end side of the ferrule 11 can be stably welded and fixed to the fixing portion 10 in a height position as approximately set. Therefore, the work for correcting the fixed height position of the ferrule 11 can be approximately omitted. Further, yield of the semiconductor laser module 1 can be improved.

Further, in this embodiment, only the clamping fixing portion 18 of the ferrule 11 is formed in the planar shape. However, for example, as shown in FIG. 6A, a portion from a front end face 11a of the ferrule 11 to the clamping fixing portion 18 on the tip side may be also processed in the planar shape. Further, when the clamping fixing portion 18 on the rear end side of the ferrule 11 is processed in the planar shape, for example, similar to FIG. 6A, a portion from a rear end face 11b of the ferrule 11 to the clamping fixing portion 18 on the rear end side may be also processed in the planar shape.

Further, as shown in FIG. 6B, a portion from the front end face 11a of the ferrule 11 to the rear end face 11b through both the clamping fixing portions 18 on the tip side and the rear end side may be also processed in the planar shape.

Further, the distance D between the clamping fixing portions 18 on both the sides of the ferrule 11 is suitably set in consideration of the distance between the fixing portions 10a and 10b, etc. Therefore, as shown in FIG. 6D, the distance between the clamping fixing portions 18 on both the sides of the ferrule 11 may be widened in comparison with the case of FIG. 2B, and may be also reversely narrowed in comparison with the case of FIG. 2B.

Further, in this embodiment, the clamping fixing faces of the fixing portions 10a, 10b are set to faces perpendicular to the base 6. However, for example, as shown in FIG. 6E, the clamping fixing faces of the fixing portions 10a, 10b may be also formed in a planar shape having an inclination. In this case, a face of the clamping fixing portion 18 of this ferrule 11 is preferably formed in a planar shape inclined along the clamping fixing face of each of the fixing portions 10a, 10b. Since the clamping fixing portion 18 of the ferrule 11 is formed on a face according to the shape of the clamping fixing face of each of the fixing portions 10a, 10b in this way, the clearances between the clamping fixing portion 18 of the ferrule 11 and the fixing portions 10a, 10b can be easily managed in comparison with a case in which the clamping fixing portion 18 of the ferrule 11 is set to a columnar curved surface.

Further, for example, as shown in FIG. 6F, a V-groove in a longitudinal direction of the ferrule 11 may be also formed in the clamping fixing portion 18 of the ferrule 11 instead of the formation of the clamping fixing portion 18 of the ferrule 11 in the perpendicular planar shape. In this case, for example, the clamping fixing face of each of the fixing portions 10a, 10b preferably has a planar shape inclined along the inner wall face of an upper side in the V-groove of the clamping fixing portion 18 of this ferrule 11. In this case, the clearances between the clamping fixing portion 18 of the ferrule 11 and the fixing portions 10a, 10b can be also easily managed.

Further, for example, the clamping fixing face of each of the fixing portions 10a, 10b may be also formed on a curved surface convex on the inside as shown in FIG. 6G. In this case, the clamping fixing portion 18 of the ferrule 11 is preferably formed in a curved surface shape convex on the outside along the clamping fixing face of each of the fixing portions 10a, 10b. Thus, the clearances between the clamping fixing portion 18 of the ferrule 11 and the fixing portions 10a, 10b can be easily managed in comparison with a case in which the clamping fixing portion 18 of the ferrule 11 is formed on the columnar curved surface.

Further, for example, the clamping fixing face of each of the fixing portions 10a, 10b may be also formed on a curved surface convex on the outside as shown by FIG. 6H. In this case, the clamping fixing portion 18 of the ferrule 11 is also preferably formed in a curved surface shape convex on the inside along the clamping fixing face of each of the fixing portions 10a, 10b. In this case, similar to the above case, the clearances between the clamping fixing portion 18 of the ferrule 11 and the fixing portions 10a, 10b can be easily managed in comparison with the case in which the clamping fixing portion 18 of the ferrule 11 is formed on the columnar curved surface.

As mentioned above, various modes can be adopted with respect to the clamping fixing face of each of the fixing portions 10a, 10b, and the clamping fixing face of the ferrule 11 is preferably formed on the face of a shape along this clamping fixing face of each of the fixing portions 10a, 10b. Further, in the cases shown in FIGS. 6E to 6H, the fixing portions 10a, 10b are set to a separating type so as to easily adjust the clearances between the clamping fixing portion 18 of the ferrule 11 and the fixing portions 10a, 10b, and one or both of the fixing portions 10a, 10b may be also fixed after the height of the ferrule 11 is adjusted.

Further, in this embodiment, both of the tip side and the rear end side of the ferrule 11 are fixed to the fixing portion 10 by welding. However, for example, the rear end side of the ferrule 11 may be also fixed to the fixing portion 10 by utilizing a fixing agent such as an adhesive. Otherwise, the tip side of the ferrule 11 may be also fixed to the fixing portion 10 by utilizing a fixing agent such as an adhesive.

Further, in this embodiment, the lens 12 of the package 4 is formed in a wedge shape, but of course no shape of this lens 12 is limited to the wedge shape.

Further, in this embodiment, the base 6 is formed by combining the member 22 for mounting the semiconductor laser element and the member 23 for mounting the fixing means. However, the shape of the base 6 is not particularly limited, but may be also set to a shape shown in FIG. 7.

Further, the thermo module 5 is arranged in the semiconductor laser module shown in the embodiments. However, for example, the thermo module 5 may be omitted when no temperature control of the semiconductor laser element 2 is required. This invention is also applied even in the semiconductor laser module in which such a thermo module 5 is omitted.

What is claimed is:

1. A semiconductor laser module comprising:
a semiconductor laser element; and
an optical fiber;
wherein the optical fiber is inserted and fixed to a ferrule,
a pair of fixing portions is arranged in a mode in which a side face of the ferrule is nipped from both sides by the fixing portions,
the face of a ferrule portion nipped by the fixing portions is formed on the face of a shape along a clamping fixing face of each of the fixing portions, and
the ferrule is fixed to the fixing portions by welding on this face.

2. A semiconductor laser module according to claim 1, wherein
the clamping fixing face of the fixing portion is formed in a perpendicular planar shape, and
the face of the ferrule portion nipped by the fixing portions is also formed in a perpendicular planar shape.

3. A semiconductor laser module according to claim 1, wherein
the clamping fixing face of the fixing portion is formed in an inclined planar shape, and
the face of the ferrule portion nipped by the fixing portions is also formed in an inclined planar shape along the clamping fixing face of the fixing portion.

4. A semiconductor laser module according to claim 1, wherein
the clamping fixing face of the fixing portion is formed in a curved surface shape, and
the face of the ferrule portion nipped by the fixing portions is also formed in a curved surface shape along the clamping fixing face of the fixing portion.

5. A semiconductor laser module according to claim 1, wherein
a V-groove is formed along a longitudinal direction of the ferrule in the ferrule portion nipped by the fixing portions, and
the clamping fixing face of the fixing portion is formed as an inclined face along the inner wall face of an upper side of the V-groove of the ferrule.

6. A semiconductor laser module according to claim 1, wherein
the ferrule is nipped and fixed by the fixing portions on a tip side and a rear end side,
at least a clamping fixing portion on the tip side among the tip side and the rear end side of the ferrule is formed on the face of a shape along the clamping fixing face of the fixing portion, and
the ferrule is fixed to the fixing portions by welding on this face.

7. A semiconductor laser module according to claim 2, wherein
the ferrule is nipped and fixed by the fixing portions on a tip side and a rear end side,
at least a clamping fixing portion on the tip side among the tip side and the rear end side of the ferrule is formed on the face of a shape along the clamping fixing face of the fixing portion, and
the ferrule is fixed to the fixing portions by welding on this face.

8. A semiconductor laser module according to claim 1, wherein
the ferrule is nipped and fixed by the fixing portions on a tip side and a rear end side,
at least a clamping fixing portion on the rear end side among the tip side and the rear end side of the ferrule is formed on the face of a shape along the clamping fixing face of the fixing portion, and
the ferrule is fixed to the fixing portions by welding on this face.

9. A semiconductor laser module according to claim 2, wherein
the ferrule is nipped and fixed by the fixing portions on a tip side and a rear end side,
at least a clamping fixing portion on the rear end side among the tip side and the rear end side of the ferrule is formed on the face of a shape along the clamping fixing face of the fixing portion, and
the ferrule is fixed to the fixing portions by welding on this face.

10. A semiconductor laser module according to claim 1, wherein
a metallic film is formed by plating on an outer circumferential face of the ferrule, and
this metallic film is removed from a welding portion of the ferrule to the fixing portion.

11. A semiconductor laser module according to claim 2, wherein
a metallic film is formed by plating on an outer circumferential face of the ferrule, and
this metallic film is removed from a welding portion of the ferrule to the fixing portion.

12. A semiconductor laser module according to claim 1, wherein
the optical fiber is constructed by a lensed fiber in which a lens is formed in a tip portion for receiving a laser beam of the semiconductor laser element.

13. A semiconductor laser module according to claim 2, wherein
the optical fiber is constructed by a lensed fiber in which a lens is formed in a tip portion for receiving a laser beam of the semiconductor laser element.
